(19) United States
(12) Patent Application Publication
(10) Pub. No.: US 2026/0128562 A1
(43) Pub. Date: May 7, 2026

(54) EXTREME-COLD HIGH-POWER LASER SYSTEM

(71) Applicants: University of Central Florida Research Foundation, Inc., Orlando, FL (US); University of Ottawa, Ottawa (CA)

(72) Inventors: Chase Evan Geiger, Orlando, FL (US); Zenghu Chang, Orleans (CA); Yi Wu, Orlando, FL (US)

(21) Appl. No.: 19/381,344

(22) Filed: Nov. 6, 2025

Related U.S. Application Data
(60) Provisional application No. 63/717,143, filed on Nov. 6, 2024.

(51) Int. Cl. H01S 3/04; H01S 3/00; H01S 3/094; H01S 3/16

(52) U.S. Cl. CPC H01S 3/0407; H01S 3/0057; H01S 3/094; H01S 3/1653

(57) ABSTRACT

A laser system may include one or more pump lasers configured to provide pump light. The laser system may include an amplifier having one or more gain media cooled below 20° C. using a liquid coolant and configured to amplify seed light having a wavelength at or greater than 2 micrometers. The laser system may include an enclosure with an atmospheric regulator to enclose at least an optical path of at least the gain media and maintain an atmosphere of dry gas.

### CROSS-REFERENCE TO RELATED APPLICATIONS

The present application claims the benefit under 35 U.S.C. § 119(e) of U.S. Provisional Application Ser. No. 63/717,143, filed Nov. 6, 2024, which is incorporated herein by reference in the entirety.

### GOVERNMENT LICENSE RIGHTS

The invention was made with Government support under grant number 2207674 awarded by the National Science Foundation (NSF) and grant number FA9550-20-1-0295 awarded by the U.S. Air Force Office of Scientific Research (AFOSR). The Government has certain rights to the invention.

### TECHNICAL FIELD

The present disclosure relates to laser cooling systems, and more particularly to an extreme-cold high-power laser system using liquid coolant refrigeration to cool gain media below 0° C. for amplifying seed light having wavelengths around and/or greater than 2 micrometers.

### BACKGROUND

High-power laser systems operating at wavelengths around and/or greater than 2 micrometers have found increasing applications in scientific research, industrial processing, and medical procedures. These systems typically employ rare-earth-doped gain media such as holmium-doped or thulium-doped crystals to achieve amplification at these short-wave infrared wavelengths. However, the performance of such laser systems is often limited by thermal effects that arise during high-power operation, including reduced gain efficiency, thermal lensing, and depolarization losses that can degrade beam quality and limit achievable output powers.

Conventional cooling approaches for these laser systems include water cooling at room temperature or cryogenic cooling using liquid nitrogen at extremely low temperatures around −196° C. While cryogenic systems can provide enhanced performance through improved gain characteristics, they introduce substantial complexity, cost, and operational challenges including the need for vacuum chambers, specialized vacuum pumping systems, and handling of cryogenic fluids. Room temperature cooling systems, while simpler to implement, may not provide sufficient thermal management for high-power applications where enhanced gain performance is desired. There remains a need for cooling solutions that can provide improved performance over room temperature systems while avoiding the complexity and cost associated with cryogenic approaches.

### SUMMARY

In some embodiments, a laser system is provided. The laser system may include one or more pump lasers configured to provide pump light. The laser system may include an amplifier including one or more gain media configured to amplify seed light. The one or more gain media may have at least one of a quasi-three-level energy system or a quasi-four-level energy system. The laser system may include a cooling system configured to cool the one or more gain media to a temperature at or below −20° C. using a liquid coolant. The laser system may include an enclosure with an atmospheric regulator to enclose at least the one or more gain media and maintain an atmosphere of dry gas.

In some embodiments, the liquid coolant may include ethanol.

In some embodiments, the one or more gain media may include a rare-earth dopant.

In some embodiments, the one or more gain media may include holmium-doped yttrium lithium fluoride (Ho:YLF).

In some embodiments, the seed light may have a wavelength at or above 2 micrometers.

In some embodiments, the one or more gain media may be cooled to a temperature between −20° C. and −70° C.

In some embodiments, the laser system may further include thermal insulation positioned between the one or more gain media and a support structure to insulate the one or more gain media.

In some embodiments, the atmospheric regulator may maintain the atmosphere at less than 0.1 percent humidity.

In some embodiments, the dry gas may include dry air supplied by a dehumidification system.

In some embodiments, the enclosure may further enclose pump light for pumping the one or more gain media.

In some embodiments, a chirped-pulse amplifier (CPA) is provided. The CPA may include a stretcher configured to receive pulsed seed light and generate chirped seed light. The CPA may include one or more gain media configured to amplify the chirped seed light. The one or more gain media may have at least one of a quasi-three-level energy system or a quasi-four-level energy system. The CPA may include a cooling system configured to cool the one or more gain media to a temperature below −20° C. using a liquid coolant. The CPA may include a compressor configured to compress amplified chirped seed light to generate output light. The CPA may include thermal insulation positioned between the one or more gain media and surrounding support structures.

In some embodiments, the one or more gain media may include a rare-earth dopant.

In some embodiments, the one or more gain media may include Ho:YLF.

In some embodiments, the seed light may have a wavelength at or above 2 micrometers.

In some embodiments, the Ho:YLF gain media may be maintained at a temperature between −20° C. and −70° C.

In some embodiments, the CPA may further include an enclosure with an atmospheric regulator configured to maintain an atmosphere of dry gas around the stretcher, gain media, and compressor.

In some embodiments, the atmospheric regulator may maintain the atmosphere at less than 0.1 percent humidity.

In some embodiments, the dry gas may include dry air supplied by a dehumidification system.

In some embodiments, the stretcher and compressor may each include a chirped volume Bragg grating (CVBG).

In some embodiments, a method of operating a laser system is provided. The method may include providing pump light from one or more pump lasers. The method may include cooling one or more gain media to a temperature below −20° C. using a liquid coolant. The one or more gain media may have at least one of a quasi-three-level energy system or a quasi-four-level energy system. The method may include amplifying seed light using the cooled gain media. The method may include maintaining an atmosphere of dry gas around at least an optical path of the seed light using an atmospheric regulator within an enclosure.

In some embodiments, the liquid coolant may include ethanol.

In some embodiments, the one or more gain media may include a rare-earth dopant.

In some embodiments, cooling the one or more gain media may include maintaining a temperature between −20° C. and −70° C.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF FIGURES

The numerous advantages of the disclosure may be better understood by those skilled in the art by reference to the accompanying figures.

FIG. 1A illustrates a block diagram of an extreme-cold laser system, in accordance with one or more embodiments of the present disclosure.

FIG. 1B illustrates a block diagram of the extreme-cold laser system configured as a chirped-pulse amplifier (CPA), in accordance with one or more embodiments of the present disclosure.

FIG. 2 illustrates a block diagram of the extreme-cold laser system configured as a double-pass chirped-pulse amplifier, in accordance with one or more embodiments of the present disclosure.

FIG. 3 depicts performance plots showing seed gain and pulse energy versus temperature, in accordance with one or more embodiments of the present disclosure.

FIG. 4 depicts performance plots showing output power and transmitted pump power characteristics, in accordance with one or more embodiments of the present disclosure.

FIG. 5 illustrates a flowchart for a method of operating a laser system, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing an extreme-cold high-power laser system operating at or near atmospheric pressures in which gain media are cooled to temperatures far below 0° C. using liquid coolant refrigeration. In some embodiments, an extreme-cold laser system cools gain media to a temperature below 20° C. using liquid coolant refrigeration in an atmospheric (e.g., non-vacuum) environment. Such a configuration may be suitable for, but not limited to, amplifiers or other laser systems utilizing a quasi-three-level or quasi-four-level laser system such as, but not limited to gain media doped with rare earth elements.

As used herein, a quasi-three/four-level gain medium (or a quasi-three/four-level laser system) may refer to a laser gain medium having a quasi-three-level or a quasi-four-level energy level structure where a lower laser level is positioned close to the ground state, resulting in significant thermal population of the lower laser level at room temperature that may compete with stimulated emission and reduce gain efficiency. In such systems, the lower laser level may be thermally populated according to Boltzmann statistics, which may create a bottleneck for achieving population inversion between the upper and lower laser levels. Examples of quasi-three/four-level laser systems may include, but are not limited to, holmium-doped yttrium lithium fluoride (Ho:YLF) operating around 2.05 micrometers, holmium-doped yttrium aluminum garnet (Ho:YAG) operating around 2.09 micrometers, thulium-doped yttrium aluminum garnet (Tm:YAG) operating around 2.0 micrometers, thulium-doped yttrium lithium fluoride operating around 1.88 micrometers, thulium-doped fiber systems operating around 1.86 micrometers, or ytterbium-doped yttrium aluminum garnet (Yb:YAG) operating around 1.03 micrometers.

However, cooling such gain media to temperatures below −20° C. may reduce the thermal population of these lower levels and effectively transition the system from quasi-three/four-level closer toward true four-level operation where population inversion may be achieved more readily. This transition may result in increased gain coefficients and improved amplification efficiency compared to room temperature operation.

In embodiments, the extreme-cold laser systems disclosed herein may utilize liquid coolant refrigeration to achieve the desired operating temperatures. This approach may provide a practical balance between performance enhancement and system complexity. For example, utilizing ethanol in a standard air-cooled refrigeration system may achieve the target cooling temperatures while maintaining operational simplicity compared to cryogenic alternatives. Thermal insulation positioned between the cooled gain media and support structures may minimize heat transfer and maintain temperature stability during operation.

The extreme-cold laser systems disclosed herein may address several challenges associated with conventional cooling approaches. These challenges include, but are not limited to, the complexity and cost of vacuum-based cryogenic systems that operate at liquid nitrogen temperatures of −196° C., the limited gain efficiency of gain media operating at room temperature or moderate cooling levels, and the infrastructure requirements for maintaining ultra-low temperature operation. In traditional cryogenic approaches, vacuum chambers with costly stainless steel construction and complex vacuum pumping assemblies including roughing pumps, turbomolecular pumps, and ion pumps are typically required. Further, existing moderate cooling techniques using water cooling at room temperature or hybrid water/glycerol with thermo-electric cooling at −20° C. often provide insufficient gain enhancement for high-power applications. By utilizing a liquid coolant refrigeration system that may achieve very low temperatures while operating at atmospheric pressure, the systems disclosed herein aim to provide enhanced gain performance while reducing system complexity and operational costs.

In embodiments, an extreme-cold laser system may operate at atmospheric pressure with dry air purging instead of requiring vacuum operation like cryogenic systems. The atmospheric pressure operation may eliminate the need for vacuum chambers and associated pumping equipment while maintaining effective thermal management of the gain media. A dry air purging system may maintain humidity levels below 0.1 percent to prevent moisture-related absorption issues for wavelengths around 2-micrometers. The dry air may be supplied by a dehumidification system that removes both water vapor and carbon dioxide from compressed air, providing a cost-effective alternative to nitrogen purging systems that require liquid nitrogen dewars, pressure relief valves, and regular delivery services.

The extreme-cold laser systems disclosed herein may provide enhanced performance characteristics including 2-micron pulse energies of 6 millijoules at repetition rates of 5 kilohertz with conversion efficiencies of 38 percent for sub-10-picosecond pulse durations in some cases. However, this example is merely illustrative and should not be interpreted as limiting the scope of the present disclosure.

Various applications may benefit from the extreme-cold laser systems sources disclosed herein, including medical surgical procedures such as precision tissue ablation and ophthalmic surgery, LIDAR systems for autonomous vehicle navigation and atmospheric monitoring, industrial materials processing including laser welding and cutting of metals and polymers, remote atmospheric sensing for environmental monitoring and climate research, spectroscopic applications for chemical analysis and molecular identification, and as pump sources for mid-infrared optical parametric amplifiers operating in the 3-7 micrometer range for defense and security applications. The high-power capabilities at wavelengths greater than 2 micrometers make these systems particularly suitable for driving high harmonic generation processes in gas targets to produce extreme ultraviolet radiation and attosecond pulse generation.

The enhanced gain performance achieved through extreme-cold operation also enables the generation of high-energy pulses with durations in the femtosecond to picosecond range, which are essential for attosecond science applications including time-resolved studies of electron dynamics in atoms and molecules, investigation of ultrafast processes in condensed matter systems, and development of attosecond metrology techniques. These systems may serve as driving lasers for attosecond pulse generation through high harmonic generation in noble gas media, where the longer wavelength operation provides advantages in extending the cutoff energy and improving the conversion efficiency of the harmonic generation process compared to conventional near-infrared driving lasers.

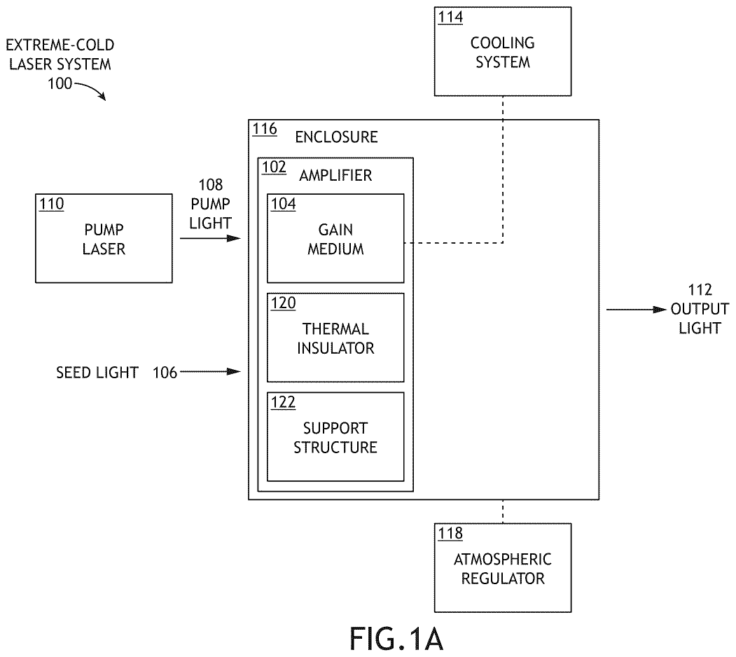

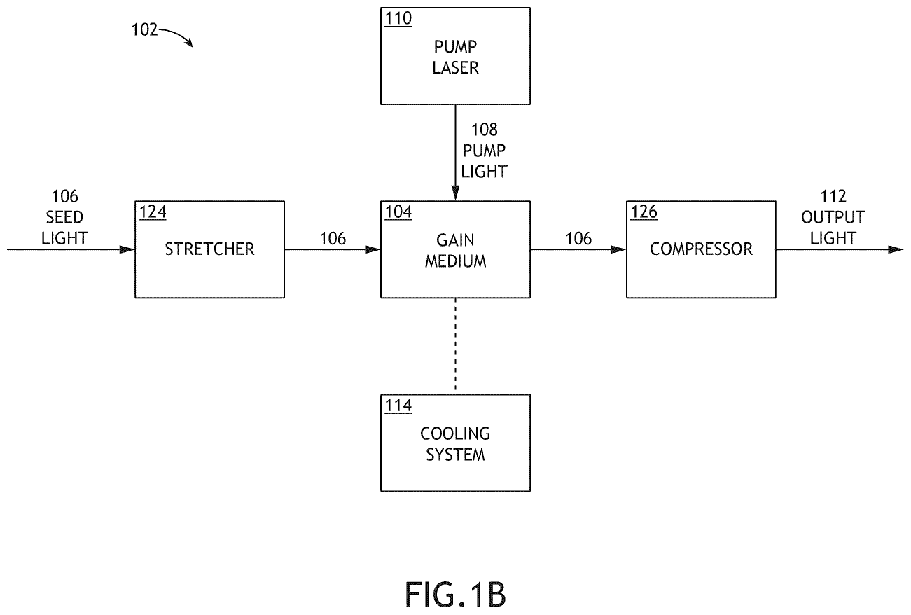

FIG. 1A illustrates a block diagram of an extreme-cold laser system 100, in accordance with one or more embodiments of the present disclosure.

In embodiments, the extreme-cold laser system 100 includes a gain medium 104 that is cooled to temperatures far below 0° C. (e.g., to temperatures at or below 20° C.) by a cooling system 114 using liquid coolant refrigeration. The gain medium 104 is optically pumped by pump light 108 provided by one or more pump lasers 110, enabling amplification of seed light 106 to produce output light 112. In some embodiments, the extreme-cold laser system 100 operates as a laser amplifier by receiving externally generated seed light 106 and amplifying it through the cooled gain medium 104 to produce higher-power output light 112. In some embodiments, the system 100 may function as a laser source by utilizing optical feedback elements such as mirrors or gratings to create a resonant cavity around the gain medium 104, enabling oscillation and direct generation of laser output without requiring external seed light.

The gain medium 104 may include any material or combination of materials that may benefit from very low temperature cooling. In some embodiments, the gain medium 104 may include a rare-earth dopant such as, but not limited to holmium, thulium, ytterbium, erbium, or neodymium. Further, the gain medium 104 may include any host material such as, but not limited to, yttrium lithium fluoride (YLF), yttrium aluminum garnet (YAG), yttrium orthovanadate (YVO4), calcium fluoride (CaF2), or silicate glass matrices. The selection of the specific rare-earth dopant and host material combination may depend on the desired operating wavelength, power requirements, and thermal characteristics.

The seed light 106 generated and/or amplified by the gain medium 104 may have any wavelength. Non-limiting examples of quasi-three/four-level laser systems and associated seed light 106 wavelengths include, but are not limited to, holmium-doped yttrium lithium fluoride (Ho:YLF) operating on seed light 106 around 2.05 micrometers, holmium-doped yttrium aluminum garnet operating on seed light 106 around 2.09 micrometers, thulium-doped yttrium aluminum garnet (Tm:YAG) operating on seed light 106 around 2.0 micrometers, thulium-doped yttrium lithium fluoride operating on seed light 106 around 1.88 micrometers, thulium-doped fiber systems operating on seed light 106 around 1.86 micrometers, or ytterbium-doped yttrium aluminum garnet (Yb:YAG) operating on seed light 106 around 1.03 micrometers.

The pump lasers 110 may provide pump light 108 having any wavelength suitable for pumping the gain media 104. For example, the extreme-cold laser system 100 may include, but are not limited to, thulium lasers operating around 1.9-2.0 micrometers, which may be suitable for pumping holmium-doped gain media.

The cooling system 114 may include any combination of components suitable for non-cryogenic cooling. The cooling system 114 may utilize any suitable liquid coolant such as, but not limited to, ethanol. The cooling system 114 may include a chiller unit that circulates liquid coolant through a closed-loop system to extract heat from the gain medium 104. Thermal contact elements may be positioned around or in direct contact with the gain medium 104 to facilitate heat transfer from the gain medium to the circulating liquid coolant. Insulated tubing may connect the chiller unit to the thermal contact elements, allowing the liquid coolant to flow between the chiller and the gain medium while minimizing heat loss during transport. For example, the cooling system 114 may utilize vacuum-jacketed stainless steel hose to maintain thermal efficiency and prevent condensation. The cooling system 114 may further include temperature monitoring and control components to maintain precise temperature regulation of the gain medium 104 during operation.

The cooling system 114 may cool the gain medium 104 to a temperature or within a temperature range that provides enhanced performance over conventional cooling approaches. For example, the gain medium 104 may be cooled to −45° C. As another example, the gain medium 104 may be cooled to temperatures below 0° C., below −20° C., below −40° C., or below −60° C. depending on the specific application requirements and desired performance characteristics.

In some embodiments, the gain medium 104 may be cooled to temperatures between −20° C. and −70° C. More specifically, the gain medium 104 may be cooled to temperatures between −20° C. and −50° C., between −20° C. and −60° C., or between −30° C. and −70° C. These temperature ranges may be selected based on the specific gain medium composition, desired amplification characteristics, and system complexity considerations.

In some embodiments, the extreme-cold laser system 100 includes a thermal insulator 120 between the gain medium 104 and a support structure 122 to insulate the gain medium 104 from thermal influences of the surrounding environment. The thermal insulator 120 may minimize heat transfer between the cooled gain medium 104 and the support structure 122, thereby maintaining temperature stability and reducing thermal gradients that could affect beam quality. The thermal insulator 120 may include any insulating material such as, but not limited to, glass, glass-mica ceramic, or fiberglass. In some cases, the thermal insulator 120 may comprise multiple layers of different insulating materials to optimize thermal performance while maintaining mechanical stability. The thermal insulator 120 may also include reflective barriers such as aluminized films or multi-layer insulation to reduce radiative heat transfer. The thickness and configuration of the thermal insulator 120 may be selected based on the operating temperature differential between the gain medium 104 and the ambient environment, with thicker insulation layers potentially providing better thermal isolation for larger temperature differences.

In some embodiments, the extreme-cold laser system 100 includes components to regulate an atmosphere around the gain medium 104. For example, the extreme-cold laser system 100 may include an enclosure 116 to enclose at least the gain medium 104. In some cases, the enclosure 116 further encloses a portion of the optical path of the seed light 106 and/or the output light 112. An atmospheric regulator 118 may be connected to the enclosure 116 to maintain an atmosphere of a selected composition and/or pressure.

The atmospheric regulator 118 may include any components suitable for regulating the atmosphere. In some embodiments, the atmospheric regulator 118 includes a dehumidifier to control humidity (e.g., water concentration) in the enclosure 116. For example, it may be desirable for some laser systems to maintain at atmosphere of dry gas with less than 0.1 percent humidity to prevent absorption of laser light (e.g., pump light 108 and/or seed light 106). In some embodiments, the atmospheric regulator 118 includes pumps, tanks, valves, and other equipment to purge and backfill the enclosure 116 with a desired gas such as, but not limited to nitrogen.

Referring now to FIG. 1B, the extreme-cold laser system 100 may be implemented as any type of laser source or laser amplifier. FIG. 1B illustrates a block diagram of an extreme-cold laser system 100 including a chirped-pulse amplifier (CPA), in accordance with one or more embodiments of the present disclosure. Such a configuration may provide high-power laser operation while maintaining pulse quality and temporal characteristics.

As shown in FIG. 1B, the amplifier 102 may include a stretcher 124 configured to receive pulsed seed light 106 and generate chirped seed light. For example, the stretcher 124 may temporally broaden the seed light 106 by introducing controlled dispersion, which reduces the peak power of the pulses while preserving the total pulse energy. The chirped seed light may then be directed to the gain medium 104 for amplification. Following amplification, the system includes a compressor 126 configured to compress the amplified chirped seed light to generate output light 112. The compressor 126 may reverse the temporal dispersion introduced by the stretcher 124, thereby restoring the pulse duration while maintaining the increased pulse energy achieved through amplification.

The stretcher 124 and compressor 126 may be implemented using any suitable dispersive optical elements to achieve the desired temporal pulse manipulation. In some embodiments, these components may utilize diffraction gratings, prisms, or chirped mirrors to introduce controlled chromatic dispersion. The stretcher 124 and compressor 126 may be configured as separate optical components, each optimized for their specific function, or they may be combined into a single optical element that provides both stretching and compression capabilities. For example, a single chirped volume Bragg grating may serve as both the stretcher and compressor by utilizing different beam paths or orientations through the same dispersive element.

The amplifier 102 may generally include any number of amplification stages and provide any number of amplification passes per stage.

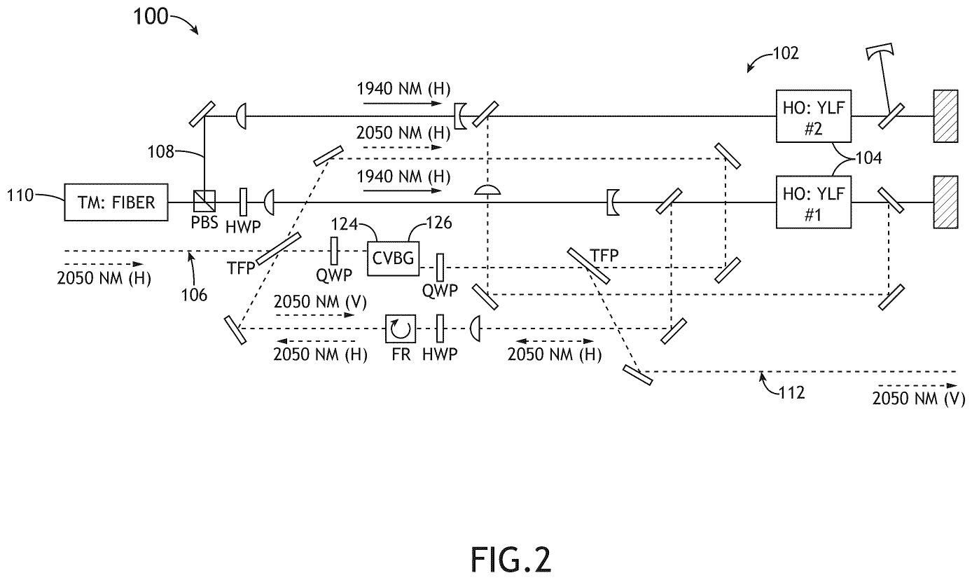

FIG. 2 illustrates a block diagram of an extreme-cold laser system 100 configured as a double-pass chirped-pulse amplifier, in accordance with one or more embodiments of the present disclosure. In this specific implementation, the extreme-cold laser system 100 may operate as a double-pass Ho:YLF CPA pumped by a thulium fiber pump laser 110 around 1.94 micrometers. In this configuration, the two holmium-doped yttrium lithium fluoride (Ho:YLF) gain media 104 may operate with seed light 106 with wavelengths around 2.05 micrometers.

The amplifier 102 may include various optical components to direct and manipulate the pump light 108 and the seed light 106. For example, FIG. 2 depicts various dichroic mirrors to simultaneously manipulate the pump light 108 and the seed light 106 after amplification (e.g., for splitting or recombination). As another example, FIG. 2 depicts various polarization control optics including half waveplates (HWP), quarter waveplates (QWP), and a Faraday rotator for injection and extraction of light.

FIG. 2 further illustrates a configuration in which the stretcher 124 and the compressor 126 are formed from a common dispersion element, which is depicted here as a chirped volume Bragg grating (CVBG).

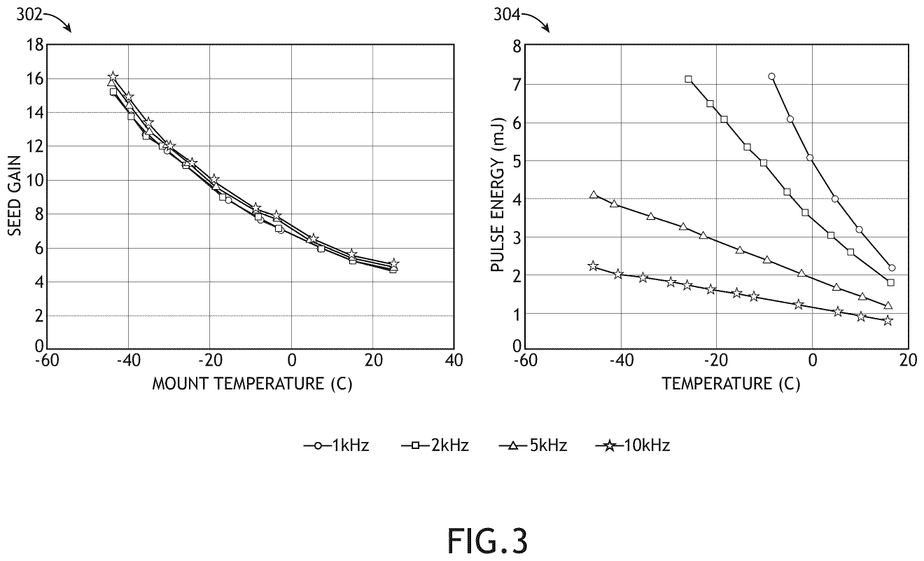

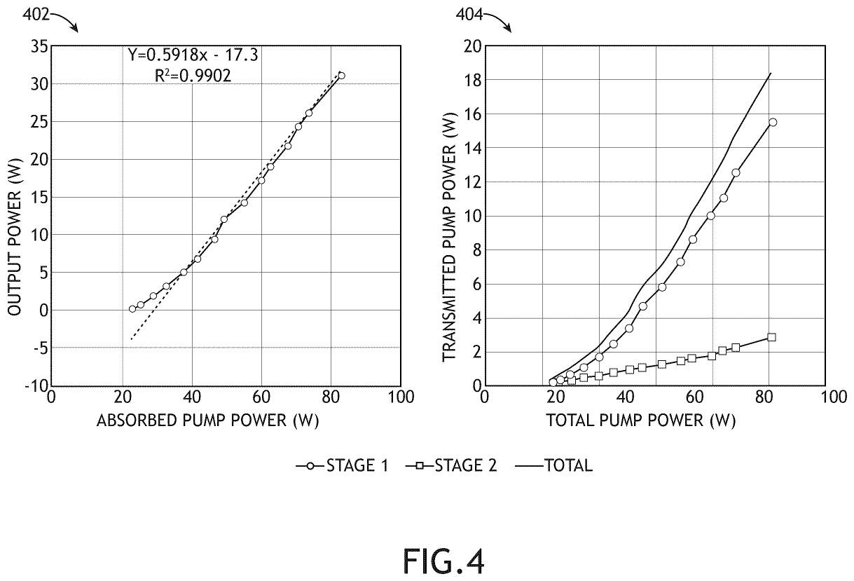

FIGS. 3-4 depict performance characteristics of an example extreme-cold laser system 100 as shown in FIG. 2.

FIG. 3 depicts two plots showing seed gain and pulse energy of an extreme-cold laser system 100 at different temperatures, in accordance with one or more embodiments of the present disclosure. A plot 302 on the left shows seed gain as a function of mount temperature at different repetition rates including 1 kHz, 2 kHz, 5 kHz, and 10 kHz. In particular, plot 302 provides single-pass average power gain in a first stage of the extreme-cold laser system 100 at 40-W pumping. In all cases, the seed gain increases as the temperature is reduced. A plot 304 on the right shows pulse energy in millijoules as a function of temperature in degrees Celsius, with curves corresponding to the same repetition rates of 1 kHz, 2 kHz, 5 kHz, and 10 kHz. In particular, plot 304 depicts the pulse energy after double-pass amplification prior to the compressor 126. In all cases, decreasing the temperature results in increased pulse energy output from the extreme-cold laser system 100. However, the effects are more pronounced as the repetition rate is decreased.

FIG. 4 depicts two plots depicting the extreme-cold laser system 100, in accordance with one or more embodiments of the present disclosure. A plot 402 on the left displays double-pass output power as a function of absorbed pump power at −45 degrees C., showing a nearly linear relationship. A plot 404 on the right shows transmitted pump power in watts as a function of total pump power in watts for a first amplification stage, a second amplification stage, and total amplification. The plot 404 shows nearly linear gain performance over a range of 40-100 W of pump power.

The performance data in FIGS. 3-4 demonstrates significant improvements across multiple temperature ranges. At temperatures below 0° C., measurable gain improvements are observed compared to room temperature operation. At temperatures below −20° C., substantial gain increases of 2-3× are achieved. At temperatures below −40° C., gain improvements of 3-4× or greater are demonstrated, with some configurations showing gains exceeding 15× at −45° C. compared to room temperature operation.

The temperature-dependent performance characteristics enable selection of optimal operating ranges based on specific application requirements. For applications requiring moderate performance improvements with simplified cooling requirements, operation between 0° C. and −30° C. may be sufficient. For applications demanding maximum performance, operation between −40° C. and −70° C. may provide optimal results.

Referring generally to FIGS. 2-4, it is to be understood that FIGS. 2-4 are provided solely for illustrative purposes and should not be interpreted as limiting the scope of the present disclosure. For example, the extreme-cold laser system 100 is not limited to CPA systems or the selection of any particular number of amplification stages or passes. As another example, the extreme-cold laser system 100 is not limited to the particular gain media 104 or pump lasers 110 shown. Further, the data presented in FIGS. 3-4 is not limiting on the capabilities of the extreme-cold laser system 100 but are rather provided as non-limiting examples.

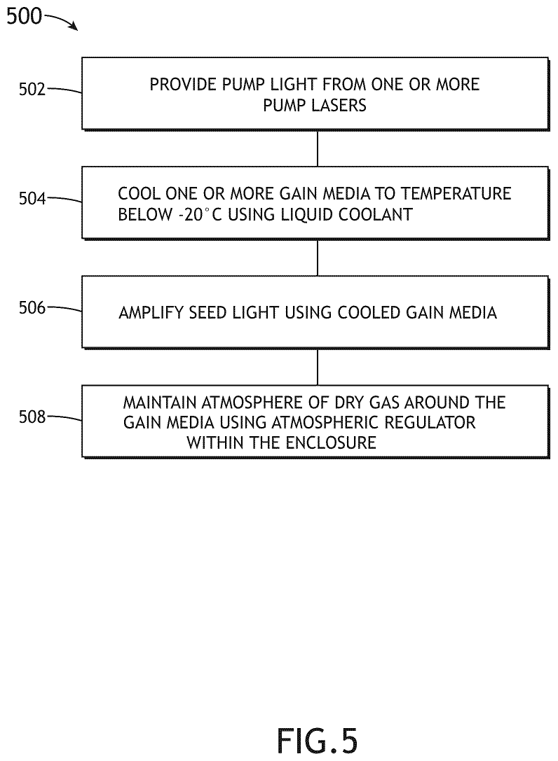

FIG. 5 illustrates a flowchart for a method 500 of operating a laser system, in accordance with one or more embodiments of the present disclosure. The embodiments and enabling technologies described in the context of the extreme-cold laser system 100 may be extended to the method 500. However, the method 500 is not limited to the architecture of the extreme-cold laser system 100.

The method 500 may include a step 502 of providing pump light from one or more pump lasers. In some cases, the pump light may be provided by the pump lasers 110 of the extreme-cold laser system 100. For example, the pump lasers 110 may generate pump light 108 having wavelengths suitable for optically pumping gain media with quasi-three/four-level energy systems. In some implementations, the pump lasers 110 may comprise thulium fiber lasers operating around 1.94 micrometers to provide pump light 108 for holmium-doped gain media. The pump light 108 may be delivered to the gain medium 104 through optical components such as dichroic mirrors, focusing lenses, or fiber coupling systems to achieve efficient absorption and population inversion in the gain medium 104.

The method 500 may include a step 504 of cooling one or more gain media to a temperature far below 0° C. (e.g., below −20° C.) using a liquid coolant, wherein the one or more gain media have a quasi-three/four-level energy system. In some cases, the cooling may be performed by the cooling system 114 of the extreme-cold laser system 100. For example, the cooling system 114 may circulate liquid coolant such as ethanol through thermal contact elements positioned around the gain medium 104 to extract heat and maintain very low temperatures. In some implementations, the gain medium 104 may be cooled to temperatures between −20° C. and −70° C. to reduce thermal population of lower laser levels and effectively transition the quasi-three/four-level system toward four-level operation. The gain medium 104 may comprise rare-earth dopants such as holmium, thulium, or ytterbium in host materials such as yttrium lithium fluoride or yttrium aluminum garnet.

The method 500 may include a step 506 of amplifying seed light using the cooled gain media. In some cases, the amplification may be performed by the gain medium 104 of the extreme-cold laser system 100 after cooling to sub-zero temperatures. For example, the seed light 106 may be directed through the cooled gain medium 104 where stimulated emission processes amplify the optical signal to produce higher-power output light 112. In some implementations, the seed light 106 may have wavelengths at or above 2 micrometers such as, but not limited to, around 2.05 micrometers for holmium-doped yttrium lithium fluoride gain media or around 2.09 micrometers for holmium-doped yttrium aluminum garnet gain media. The amplification process may benefit from the reduced thermal population of lower laser levels achieved through extreme-cold operation, resulting in increased gain coefficients and improved conversion efficiency compared to room temperature operation.

The method 500 may include a step 508 of maintaining an atmosphere of dry gas around at least the one or more gain media using an atmospheric regulator within an enclosure. In some cases, the atmosphere may be maintained by the atmospheric regulator 118 within the enclosure 116 of the extreme-cold laser system 100. For example, the atmospheric regulator 118 may include dehumidification systems that remove water vapor and carbon dioxide from compressed air to maintain humidity levels below 0.1 percent. In some implementations, the dry gas may comprise dry air supplied by a dehumidification system rather than nitrogen purging, which may eliminate the costs associated with liquid nitrogen dewars and regular delivery services. The enclosure 116 may surround the optical path of the seed light 106 and output light 112 to prevent moisture-related absorption issues that could degrade performance at wavelengths around 2 micrometers.

The steps of the method 500 may work together to enable efficient amplification at extreme-cold temperatures while preventing moisture-related issues. The cooling of the gain medium 104 in the step 504 may enhance the population inversion and gain characteristics, while the provision of pump light 108 in the step 502 may supply the energy for optical pumping. The amplification process in the step 506 may benefit from both the enhanced gain characteristics achieved through cooling and the stable pumping conditions. The maintenance of a dry atmosphere in the step 508 may prevent water vapor absorption that could otherwise reduce the effectiveness of both the pump light 108 and the seed light 106, thereby preserving the amplification efficiency achieved through the extreme-cold operation.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A laser system comprising:
one or more pump lasers configured to provide pump light;
an amplifier including one or more gain media configured to amplify seed light, wherein the one or more gain media have at least one of a quasi-three-level energy system or a quasi-four-level energy system;
a cooling system configured to cool the one or more gain media to a temperature at or below −20° C. using a liquid coolant; and
an enclosure with an atmospheric regulator to enclose at least the one or more gain media and maintain an atmosphere of dry gas.

2. The laser system of claim 1, wherein the liquid coolant comprises ethanol.

3. The laser system of claim 1, wherein the one or more gain media comprise a rare-earth dopant.

4. The laser system of claim 1, wherein the one or more gain media comprise holmium-doped yttrium lithium fluoride (Ho:YLF).

5. The laser system of claim 1, wherein the seed light has a wavelength at or above 2 micrometers.

6. The laser system of claim 1, wherein the one or more gain media are cooled to a temperature between −20° C. and −70° C.

7. The laser system of claim 1, further comprising thermal insulation positioned between the one or more gain media and a support structure to insulate the one or more gain media.

8. The laser system of claim 1, wherein the atmospheric regulator maintains the atmosphere at less than 0.1 percent humidity.

9. The laser system of claim 8, wherein the dry gas comprises dry air supplied by a dehumidification system.

10. The laser system of claim 1, wherein the enclosure further encloses the pump light for pumping the one or more gain media.

11. A chirped-pulse amplifier comprising:
a stretcher configured to receive pulsed seed light and generate chirped seed light;
one or more gain media configured to amplify the chirped seed light, wherein the one or more gain media have at least one of a quasi-three-level energy system or a quasi-four-level energy system;
a cooling system configured to cool the one or more gain media to a temperature below −20° C. using a liquid coolant;
a compressor configured to compress amplified chirped seed light to generate output light; and
thermal insulation positioned between the one or more gain media and surrounding support structures.

12. The chirped-pulse amplifier of claim 11, wherein the one or more gain media comprise a rare-earth dopant.

13. The chirped-pulse amplifier of claim 11, wherein the one or more gain media comprise holmium-doped yttrium lithium fluoride (Ho:YLF).

14. The chirped-pulse amplifier of claim 11, wherein the pulsed seed light has a wavelength at or above 2 micrometers.

15. The chirped-pulse amplifier of claim 11, wherein the one or more gain media are maintained at a between −20° C. and −70° C.

16. The chirped-pulse amplifier of claim 15, further comprising an enclosure with an atmospheric regulator configured to maintain an atmosphere of dry gas around the stretcher, gain media, and the compressor.

17. The chirped-pulse amplifier of claim 16, wherein the atmospheric regulator maintains the atmosphere at less than 0.1 percent humidity.

18. The chirped-pulse amplifier of claim 17, wherein the dry gas comprises dry air supplied by a dehumidification system.

19. The chirped-pulse amplifier of claim 11, wherein the stretcher and the compressor each comprise a chirped volume Bragg grating (CVBG).

20. A method of operating a laser system comprising:
providing pump light from one or more pump lasers;
cooling one or more gain media to a temperature below −20° C. using a liquid coolant, wherein the one or more gain media have at least one of a quasi-three-level energy system or a quasi-four-level energy system;
amplifying seed light using the one or more gain media; and
maintaining an atmosphere of dry gas around at least an optical path of the seed light using an atmospheric regulator within an enclosure.

21. The method of claim 20, wherein the liquid coolant comprises ethanol.

22. The method of claim 20, wherein the one or more gain media comprise a rare-earth dopant.

23. The method of claim 22, wherein cooling the one or more gain media comprises maintaining a temperature between −20° C. and −70° C.
